(19) United States
(12) Patent Application Publication
(10) Pub. No.: US 2001/0028008 A1
(43) Pub. Date: Oct. 11, 2001

(54) Process for grinding plastics

(76) Inventor: Hubert Muller, Frankfurt (DE)

Correspondence Address: CONNOLLY AND HUTZ, P.O. Box 2207, Wilmington, DE, 19899, US

(21) Appl. No.: 09/801,423

(22) Filed: Mar. 8, 2001

(30) Foreign Application Priority Data
Mar. 10, 2000 (DE) 10011348.6-23

(51) Int. Cl. B02C 17/06

(52) U.S. Cl. 241/175

(57) ABSTRACT

The invention relates to a process for grinding plastics in bead mills, which comprises carrying out the grinding in a centrifugal-agitator bead mill, in which the grinding beads and the plastics are exposed to a centrifugal force field in a rotating drum.

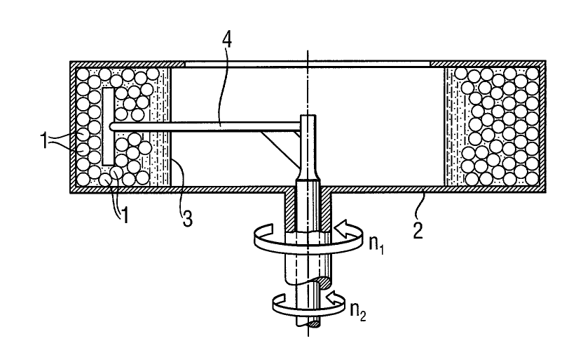

### DESCRIPTION

The invention relates to a process for grinding plastics in bead mills.

In the comminution (grinding) of solids, for example of plastics in bead mills, the stress built up within the structure of the solid as a result of mechanical load placed upon particles is sufficient to form cracks and finally to fracture the particle.

The grinding of plastics in the range below about 100 μm is technically difficult, since the particles are elastic and are frequently merely distorted rather than fractured by the load applied. Low temperatures are frequently used in order to embrittle the particles prior to or during the grinding process and to improve grindability. With some plastics even this process fails to give comminution at high levels of fineness.

The object on which the invention was based was to further improve, or to enable, the grinding of plastics in the range below about 100 μm.

For the comminution of biological cells, e.g. yeast cells or bacterial cultures, a specific mill has been developed, known as the centrifugal-agitator bead mill, abbreviated to CABM [Richard Wúrtz: Entwicklung einer neuartigen Zentrifugalrúhrwerkkugelmuhle zum Aufschluβ von Mikroorganismen [Development of a novel centrifugal-agitator bead mill for macerating microorganisms] Dissertation, University of Stuttgart 1997]. This mill (see figure) operates as an agitator bead mill, but the grinding beads 1 are in a centrifugal force field brought about by the rotation of the drum 2 (rotation rate n₁). The product-to be ground is likewise added to the grinding beads together with a suitable liquid 3, e.g. water. An agitator 4 then agitates the fill of grinding beads, product and liquid at the rotation rate n₂≠n₁. Because of the centrifugal field, the shear forces exerted when the grinding beads slide over one another are considerably higher than is the case with a simple filling of beads under gravity.

Previously known mills have not been capable of comminuting yeast cells;, since these have extremely robust cell walls. But the load in the event that a yeast cell finds its way between the grinding beads of the CABM is sufficiently high to break open the cell wall.

Completely surprisingly, it has now been found that the object mentioned can be achieved by carrying out the grinding in a centrifugal-agitator bead mill, by exposing the grinding beads and the plastics to a centrifugal force field in a rotating drum.

The invention therefore provides a process for grinding plastics in bead mills, which comprises carrying out the grinding in a centrifugal-agitator bead mill, in which the grinding beads and the plastics are exposed to a centrifugal force field in a rotating drum.

The invention therefore also provides for the use of centrifugal bead mills for grinding plastics. The invention further provides the plastic powders obtainable and/or obtained.

The process of the invention is preferably suitable for any type of plastic, such as synthetic plastics, modified naturally occurring materials, polymers, polycondensates, polyadducts, thermosets and thermoplastics, as set out in “Die Kunststoffe und ihre Eigenschaften” [Plastics and their properties], Hans Domininghaus, VDI-Verlag GmbH, Dússeldorf 1986, which is hereby incorporated into this application by way of reference. The process of the invention may also be advantageously carried out under cold conditions, e.g. by adding liquid nitrogen or dry ice or other coolants in a manner known per se, at temperatures from below 25° C. down to −190° C. The operating pressure may be superatmospheric or subatmospheric, preferably atmospheric pressure, and the mode of operation may be batch or continuous, preferably batch, and the grinding may be dry or wet, preferably wet, and the grinding bead diameter may be 20-3000 μm, for example, and the grinding beads may be of glass, zirconium oxide, zircon, silicon carbide, quartz, metal, or ceramic, for example. The arrangement of the drum may be vertical or horizontal, and the agitator may run faster than the drum with n₂>n₁, or slower than the drum, with n₂<n₁.

The process of the invention permits the preparation of pulverulent plastics with a ponderal median particle size d_{50, 3} of less than or equal to 30 μm, preferably less than 24 μm, particularly preferably less than or equal to 20 μm, and very particularly preferably less than or equal to 10 μm.

The invention is described in more detail below using examples and tests. No resultant restriction of any kind is intended.

A CABM as mentioned at the outset was used to study the grinding of plastics. In tests on conventional mills, including jet mills and agitator bead mills, thermoplastics and thermosets, such as polyamide (PA), polybenzimidazole (PBI), polyethylene (PE), polyetherimide (PEI), polymethyl methacrylate (PMMA), or polypropylene (PP), e.g., GUR® (ultrahighmolecular PE from Ticona GmbH, D-60528 Frankfurt), proved to be very difficult or even impossible to grind, that is to say that the degree of fineness after grinding hardly differed from that prior to grinding if the initial charge was a powder with a ponderal median particle size d50, 3 below about 50-100 μm. Surprisingly, the CABM gave a marked grinding effect, that is to say that the ground product was significantly finer than the unground material. The ranges of fineness achievable with some of the plastics had not previously been achieved using conventional mills, as far as is known.

During the grinding of the plastics given in the table below, the diameter of the grinding chamber in the CABM was about 200 mm, the rotation rate of the drum was 1500 rpm, the rotation rate of the agitator was 1900 rpm, and the diameter of the grinding beads was 500-750 μm, and the mill temperature was 30-60° C. The grinding beads were of zirconium oxide, the amount of product was 30 g, the amount of liquid was 120 g, and the tests were carried out with batch operation, the test duration being from 5 to 10 min.

The following results were obtained:

| | d_{50,3} prior to | d_{50,3} after | |
|---|---|---|---|
| Product | grinding | grinding | Grinding parameters |
| PMMA | 40 μm | 24 μm | n₁ = 1500, n₂ = 1900, |
| PEI | 54 μm | 10 μm | n₁ = 1500, n₂ = 1950, |

1. A process for grinding plastics in bead mills, which comprises carrying out the grinding in a centrifugal-agitator bead mill, in which the grinding beads and the plastics are exposed to a centrifugal force field in a rotating drum.

2. The process as claimed in claim 1, wherein within the drum an agitator has been arranged so that it can rotate, and runs slower than or faster than the rotating drum.

3. The use of centrifugal-agitator bead mills for grinding plastics.

4. A plastic obtainable by a process as claimed in claim 1 or 2.

5. A plastic obtained by a process as claimed in claim 1 or 2.

6. A plastic powder with a ponderal median particle size d_{5, 3} of less than or equal to 30 μm.
